(19) United States
(12) Patent Application Publication
(10) Pub. No.: US 2004/0009397 A1
(43) Pub. Date: Jan. 15, 2004

(54) Binder for lithium-sulfur battery, positive active material composition comprising same and lithium-sulfur battery comprising same

(75) Inventors: Seok Kim, Incheon-City (KR); YongJu Jung, Suwon-City (KR); Jan-Dee Kim, Seoul (KR); Ji-Seong Han, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG SDI Co., Ltd., Suwon-city (KR)

(21) Appl. No.: 10/431,367

(22) Filed: May 8, 2003

(30) Foreign Application Priority Data
Jul. 10, 2002 (KR) 2002-40005

(51) Int. Cl. H01M 4/62; C08F 14/18; C08F 114/18

(52) U.S. Cl. 429/217; 526/242; 526/250

(57) ABSTRACT

A binder for a lithium-sulfur battery utilizes a fluorine-included polymer.

### CROSS-REFERENCE TO RELATED APPLICATIONS

This application is based on application No. 2002-40005 filed in the Korean Intellectual Property Office on Jul. 10, 2002, the disclosure of which is incorporated herein by reference.

### BACKGROUND OF THE INVENTION

1. Field of the Invention

The present invention relates to a binder for a lithium-sulfur battery, a positive active material composition comprising the same, and a lithium-sulfur battery comprising the same, and more particularly, to a binder for a lithium-sulfur battery exhibiting effective adhesion.

2. Description of the Related Art

Recently, the rapid development of smaller, lighter, and higher performance electronic and communication equipment has required the development of high performance and large capacity batteries to power such equipment. Lithium-sulfur batteries are of interest because they have the highest theoretical energy density, 2800 Wh/kg (1675 mAh/g), as compared to other batteries. In addition, sulfur is an abundant and inexpensive material, and is also environmentally friendly.

The choice of a binder is critical for determining battery performance. The requirements for the binder include no reaction with polysulfide, that is, chemical resistance to polysulfide, an ability to enhance the mechanical integrity of the positive electrode, stability at battery working temperatures, solubility in organic solvents used in slurry, insolubility in electrolytes, and high adherence.

Except for the high adherence, these physical properties have a significant effect on battery performance. Some materials satisfy such physical properties except for the high adherence, so a binder using these materials has relatively low adherence.

### SUMMARY OF THE INVENTION

It is an aspect of the present invention to provide a binder for a lithium-sulfur battery exhibiting effective adherence.

It is another aspect to provide a binder for a lithium-sulfur battery that is insoluble in an electrolyte, and has effective resistance to chemicals.

It is still another aspect to provide a positive active material composition for a lithium-sulfur battery with low binder content.

It is still another aspect to provide a lithium-sulfur battery exhibiting high capacity.

Additional aspects and advantages of the invention will be set forth in part in the description which follows and, in part, will be obvious from the description, or may be learned by practice of the invention.

These and/or other aspects may be achieved by a binder for a lithium-sulfur battery including a fluorine-included polymer.

In order to achieve these and/or other aspects, the present invention includes a positive active material composition for a lithium-sulfur battery having a positive active material, a conductive material, an organic solvent, the binder and an agent for controlling viscosity. The binder is present in the organic solvent in a distributed state in the form of an emulsion, with a binder particle size of 15 micrometers or less. The amount of the binder is 2 to 6 wt %, and preferably 2 to 3 wt %.

The present invention further includes a lithium-sulfur battery having the binder.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a graph illustrating charge and discharge characteristics of the lithium-sulfur cells according to Examples 1 and 2 of the present invention and Comparative Examples 1 and 2; and

FIG. 2 is a graph illustrating the cycle life characteristics of the cells according to Examples 1 and 2 of the present invention and Comparative Examples 1 and 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

The present invention relates to a binder for a lithium-sulfur battery which includes a fluorine-included polymer. The binder is not dissolved, but rather it is distributed in an organic solvent in the form of an emulsion. The binder is a non-aqueous material. The fluorine-included polymer is represented by the following Formula 1:

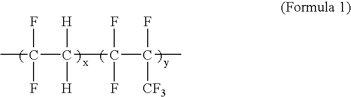

(wherein x is preferably 0.5 to 1.0, and more preferably 0.8 to 1.0;

and y is preferably 0<y≦0.5, and more preferably 0<y≦0.2)

If the value of y exceeds 0.5, the chemical resistance to an electrolyte of the binder is reduced, thus making dissolution of the electrolyte possible.

The fluorine-included polymer may be a homopolymer composed of a monomer selected from the group consisting of C₂F₃Cl, C₂H₃F and CH₃(CF₃C₂H₄)SiO; or a copolymer composed of a first monomer selected from the group consisting of C₂F₄, C₂F₃Cl, CH₂CF₂, C₂H₃F and CH₃(CF₃C₂H₄)SiO, and a second monomer selected from the group consisting of C₂H₄, C₃H₆, CH₂═CHOR (R is a C₁ to C₂₀ alkyl group), C₃F₆ and CF₂═CFOR_{f} (R_{f} is at least 1, and is preferably 1, C₁ to C₂₀ alkyl group with at least 1, and preferably 1 to 60, fluorine atoms.)

The binder for the lithium-sulfur battery may further include butadiene-included copolymers. The butadiene-included copolymers help to improve adhesion and to control swelling.

The butadiene-included copolymer is preferably acrylonitrile-butadiene-styrene rubber, acrylonitrile-butadiene rubber or a modified styrene-butadiene rubber. The modified styrene-butadiene rubber may be carboxylated styrene-butadiene rubber. An example of the copolymer is represented by the following Formula 2.

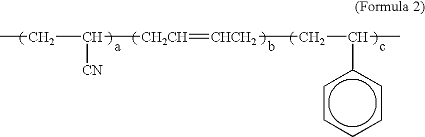

The “—(CH₂CH═CHCH₂)—” unit at the center portion has rubber-like characteristics, and the “—(CH₂—CHCN)—” and “—(CH₂—CHC₆H₅—)” units at the end portions have glass-like characteristics. Accordingly, if two of the a, b and c values are 0, the resulting polymer exhibits poor mechanical properties. In the present invention, the preferred a, b, and c values depend on the type of copolymer used. If the styrene butadiene-based polymer is used, a is 0, 5<b<40, and 60<c<95; if the acrylonitrile butadiene-based polymer is used, 60<a <95, 5<b<40, and c is 0; and if the acrylonitrile butadiene styrene-based polymer is used, 20<a <75, 5<b<20, and 20<c<75. If the a, b, and c values exceed the ranges, the binder has inappropriate mechanical properties.

If the binder uses both a butadiene-included and a fluorine-included polymer, the mixing ratio is 10 to 90: 90 to 10 by the weight ratio.

In one embodiment of the present invention, a positive active material composition having the binder includes a positive active material, a conductive material, an organic solvent, and an agent for controlling viscosity. The binder is presented in the organic solvent in a distributed state in the form of an emulsion with a binder particle size of 15 micrometers or less. That is, the conventional binder is presented in the organic solvent in a dissolved state, whereas the binder in the present invention is presented in the organic solvent in a distributed state. Positive active material particles more firmly adhere to each other via the distributed binder particles than with the dissolved binder. The adhesion increases as the size of the binder particle becomes smaller, and the preferred binder particle size of the binder is 15 micrometers or less.

The effective adhesion of the binder of the present invention permits a decrease in the amount of binder used to 2 to 6 wt %, and preferably to 2 to 3 wt % from about 20 wt %, which is required for the use of the conventional binder in the positive active material composition. The requirement of such a decreased amount of the binder allows an increase in the amount of the positive active material in the composition, which results in the provision of high capacity lithium-sulfur batteries.

The positive active material composition of the present invention includes an agent for controlling a decrease in viscosity when the binder components are combined.

The agent for controlling viscosity may be a cellulose-based polymer such as methyl cellulose, hydroxypropyl methylcellulose, hydroxyethyl-cellulose, or carboxymethyl cellulose; or polyvinyl alcohol, polyvinylpyrrolidone, polyacrylic acid, polyacrylamide, polyethyeneoxide, or polyethyleneimine. The amount of the agent for controlling viscosity is preferably 0.1 to 10 wt % of the positive active material composition. If the amount of the agent is less than 0.1 wt %, the viscosity of the positive active material composition is too low to coat on a current collector. If the amount of the agent is more than 10 wt %, the relative amount of the positive active material is reduced, thus decreasing capacity.

The positive active material may be elemental sulfur (S₈), Li₂Sₙ(n≧1), an organic-sulfur compound or a carbon-sulfur polymer.

The conductor includes an electrical conductor that facilitates the movement of electrons within the positive electrode with the sulfur-based compound. Examples of the conductive material include, but are not limited to, a conductive material such as a graphite-based material, a carbon-based material and a conductive polymer. The graphite-based material includes KS 6 (available from TIMCAL CO.); and the carbon-based material includes SUPER P (available from MMA Co.), ketjen black, denca black, acetylene black, or carbon black. The conductive polymer includes polyaniline, polythiophene, polyacetylene, or polypyrrole, or a combination thereof. The amount of the conductive agent is 5 to 20 wt %, and thus, the amount of the positive active material increases to a maximum of 92.9 wt %, which results in an increase in capacity.

The organic solvent may be any solvent as long as it is capable of homogeneously dispersing the positive active material, the binder, and the conductor. Useful solvents include acetonitrile, methanol, ethanol, tetrahydrofurane, water, isopropyl alcohol, and dimethyl formamide.

An embodiment of a positive electrode preparation of the present invention is described below.

A binder is dissolved in a solvent to prepare a binder liquid. A conductor and a positive active material are added to the binder liquid, and are mixed for at least 12 hours to prepare a positive active material composition. The resulting positive active material composition has sufficient viscosity to coat a current collector.

The positive active material composition is coated on a current collector and dried to produce a positive electrode. The current collector preferably comprises, but is not limited to, a conductive material such as stainless steel, aluminum, copper, or titanium. It is more preferable to use a carbon-coated aluminum current collector. The carbon-coated aluminum current collector has excellent adhesive properties to the coated layer that includes positive active materials, shows a lower contact resistance, and inhibits corrosion by a polysulfide in comparison with a bare aluminum current collector.

Using the positive electrode and a negative electrode, a lithium-sulfur battery is fabricated by the general procedure set forth below.

The negative electrode typically includes a negative active material selected from a lithium metal or a lithium alloy such as lithium/aluminum. In addition, during charging and discharging of the lithium-sulfur battery, the positive active material (active sulfur) converts to an inactive material (inactive sulfur), which can be attached to the surface of the negative electrode. The term “inactive sulfur”, as used herein, refers to sulfur that has no activity upon repeated electrochemical and chemical reactions and cannot participate in an electrochemical reaction of the positive electrode. The inactive sulfur on the surface of the negative electrode acts as a protective layer for the lithium negative electrode. Accordingly, inactive sulfur, for example, lithium sulfide, on the surface of the negative electrode can be used in the negative electrode.

The following examples illustrate the present invention in further detail, but it is understood that the present invention is not limited by these examples.

### EXAMPLE 1

84 wt % of elemental sulfur (S₈), 12 wt % of ketjen black (MITSUBISHI), 2 wt % of a fluorine-included binder represented by Formula 1, and 2 wt % of carboxymethyl cellulose as an agent for controlling viscosity were uniformly mixed in a water solvent to prepare a slurry.

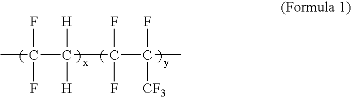

(wherein x is 0.85, and y is 0.15)

The slurry was coated on a carbon-coated Al current collector, and the coated current collector was dried to produce a positive electrode.

Using the positive electrode, a lithium foil negative electrode, a polypropylene separator, and an electrolyte, a lithium-sulfur cell was fabricated in a dry room. The electrolyte was 1 M LiSO₃CF₃ in a mixed solvent of 1,3-dioxolane/diglyme/sulforane/dimethoxy ethane (5:2:1:2 volume ratio).

### EXAMPLE 2

84 wt % of elemental sulfur (S₈), 12 wt % of ketjen black (MITSUBISHI), 1 wt % of a fluorine-included binder represented by Formula 1, 1 wt % of an acetonitrile butadiene styrene rubber binder and 2 wt % of carboxymethyl cellulose, as an agent for controlling viscosity, were uniformly mixed in a water solvent to prepare a slurry.

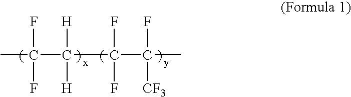

(wherein x is 0.85, and y is 0.15)

The slurry was coated on a carbon-coated Al current collector, and the coated current collector was dried to produce a positive electrode.

Using the positive electrode, a lithium foil negative electrode, a polypropylene separator, and an electrolyte, a lithium-sulfur cell was fabricated in a dry room. The electrolyte was 1 M LiSO₃CF₃ in a mixed solvent of 1,3-dioxolane/diglyme/sulforane/dimethoxy ethane (5:2:1:2 volume ratio).

### COMPARATIVE EXAMPLE 1

60 wt % of elemental sulfur (S₈), 20 wt % of ketjen black (MITSUBISHI), and 20 wt % of polyethylene oxide were uniformly mixed in an acrylonitrile solvent to prepare a slurry.

The slurry was coated on a carbon-coated Al current collector, and the coated current collector was dried to produce a positive electrode.

Using the positive electrode, a lithium foil negative electrode, a polypropylene separator, and an electrolyte, a lithium-sulfur cell was fabricated in a dry room. The electrolyte was 1 M LiSO₃CF₃ in a mixed solvent of 1,3-dioxolane/diglyme/sulforane/dimethoxy ethane (5:2:1:2 volume ratio).

### COMPARATIVE EXAMPLE 2

60 wt % of elemental sulfur (S₈), 20 wt % of ketjen black (MITSUBISHI) and 20 wt % of polyvinylpyrrolidone were uniformly mixed in an acrylonitrile solvent to prepare a slurry.

The slurry was coated on a carbon-coated Al current collector, and the coated current collector was dried to produce a positive electrode.

Using the positive electrode, a lithium foil negative electrode, a polypropylene separator, and an electrolyte, a lithium-sulfur cell was fabricated in a dry room. The electrolyte was 1 M LiSO₃CF₃ in a mixed solvent of 1,3-dioxolane/diglyme/sulforane/dimethoxy ethane (5:2:1:2 volume ratio).

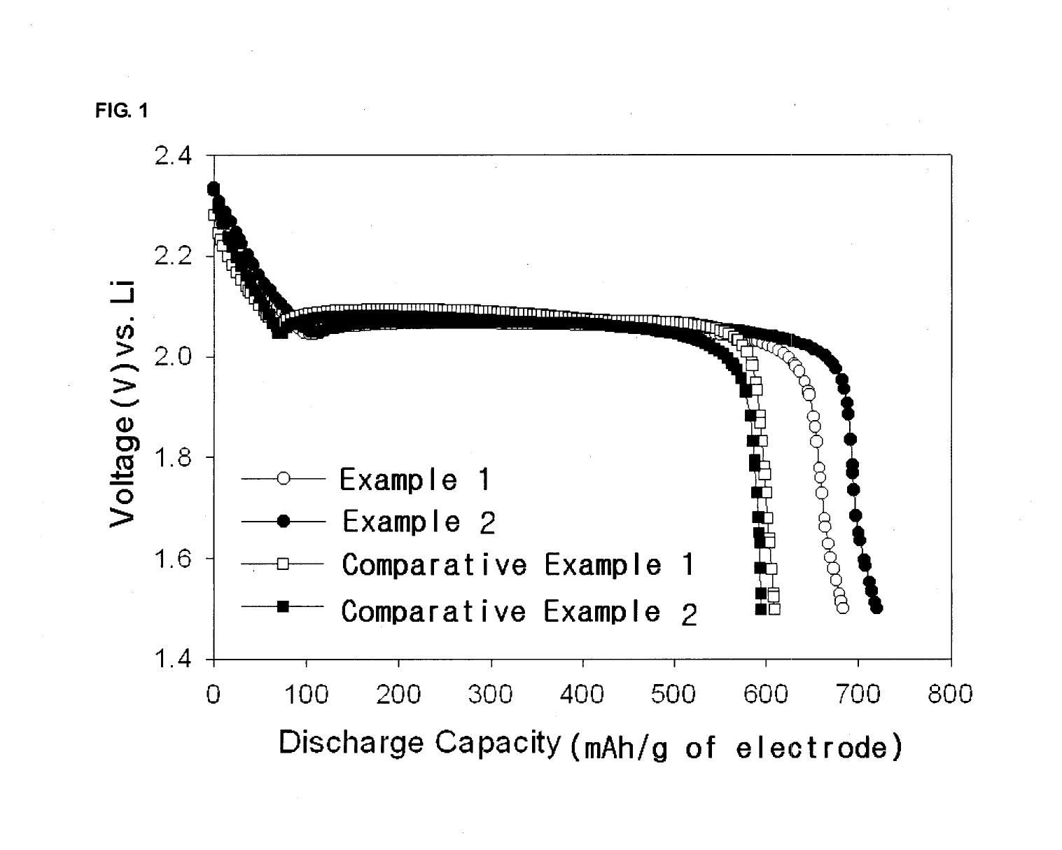

The charge and discharge characteristics of the cells according to Examples 1 and 2 and Comparative Examples 1 and 2 were measured at room temperature. The lithium-sulfur battery was initially discharged for 1 cycle at a discharging current density of 0.2 mA/cm², since the test cell had been charged on cell formation. Thereafter, a charge current density was set to 0.4 mA/cm², and the discharge current density was set to 0.2 mA/cm² (C-rate was 0.1 C). The discharge cut-off voltage was set to 1.5˜2.8 V. The results are presented in FIG. 1. It is shown from FIG. 1 that, although the discharge average voltages of the cells according to Examples 1 and 2 were similar to those according to Comparative Examples 1 and 2, the capacity per g of electrode of the cells according to Examples 1 and 2 was higher than in Comparative Examples 1 and 2.

Cycle Life Characteristics

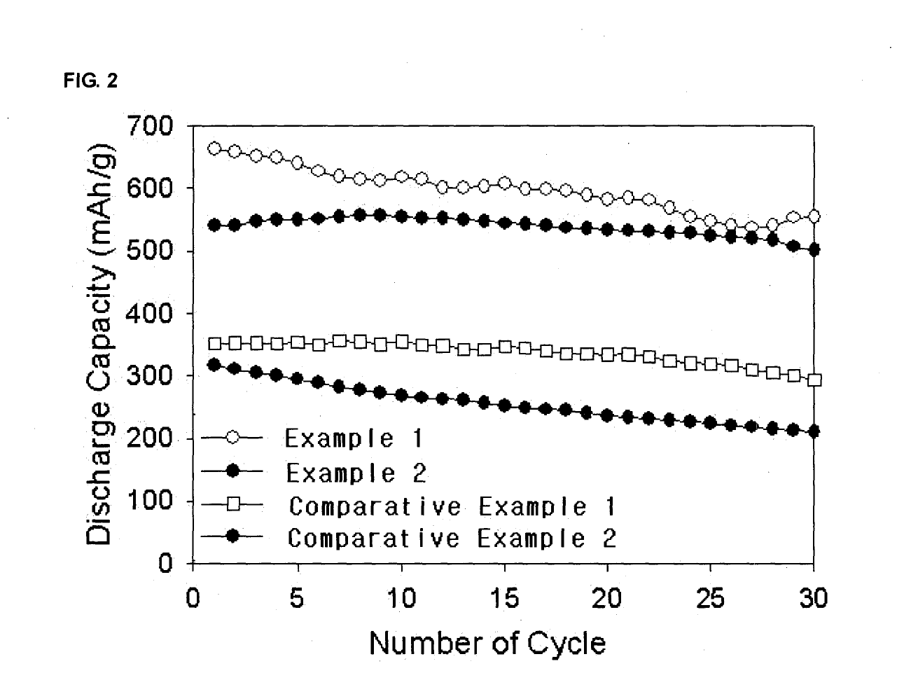

The cycle life characteristics of the cells according to Examples 1 and 2 and Comparative Examples 1 and 2 were measured at room temperature. The charge current density was set to 1.0 mA/cm² (C-rate: 0.5 C) and the discharge current density was set to 2 mA/cm² (C-rate: 1.0 C). The results are presented in FIG. 2. It is evident from FIG. 2 that the cells according to Examples 1 and 2 have surprisingly higher capacities than the cells according Comparative Example 1, and such higher capacities are still maintained during 30 charge and discharge cycles.

The binder of the present invention has excellent adhesion. Such an effective adhesion permits an increase to 84 wt % (Examples) from 60 wt % (Comparative Examples) of the positive active material, and such an increased amount of the positive active material results in the provision of high capacity lithium-sulfur batteries.

Although a few preferred embodiments of the present invention have been shown and described, it would be appreciated by those skilled in the art that changes may be made in this embodiment without departing from the principles and spirit of the invention, the scope of which is define in the claims and their equivalents.

What is claimed is:

1. A binder for a lithium-sulfur battery comprising:
a fluorine-included polymer.

2. The binder of claim 1, wherein the fluorine-included polymer is represented by Formula 1: 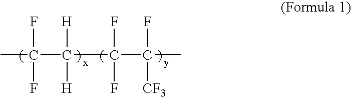
(wherein x is 0.5 to 1.0, and 0<y<0.5)

3. The binder of claim 1, wherein y exceeds 0, and is less than 0.2.

4. The binder of claim 1, wherein the fluorine-included polymer is a homopolymer selected from the group consisting of C₂F₃Cl, C₂H₃F and CH₃(CF₃C₂H₄)SiO, or a copolymer including a first monomer and a second monomer, the first monomer being selected from the group consisting of C₂F₄, C₂F₃Cl, CH₂CF₂, C₂H₃F and CH₃(CF₃C₂H₄)SiO, and the second monomer being selected from the group consisting of C₂H₄, C₃H₆, CH₂═CHOR (R is a C₁ to C₂₀ alkyl group), C₃F₆ and CF₂═CFOR_{f} (R_{f} is a C₁ to C₂₀ alkyl group with at least one fluorine atom).

5. The binder of claim 1, further comprising a butadiene-included copolymer.

6. The binder of claim 5, wherein the butadiene-included copolymer is selected from the group consisting of acrylonitrile-butadiene-styrene rubber, acrylonitrile-butadiene rubber and a modified styrene-butadiene rubber.

7. The binder of claim 5, wherein the butadiene-included copolymer is represented by Formula 2: 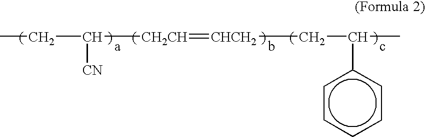
(wherein a is 0, 5<b<40, and 60<c<95;
60<a<95, 5<b<40, and c is 0; or
20<a<75, 5<b<20, and 20<c<75)

8. The binder of claim 5, wherein the butadiene-included copolymer is non-aqueous.

9. A positive active material composition for a lithium-sulfur battery comprising:
a positive active material comprising sulfur or a sulfur-based compound;
a conductive agent;
an organic solvent;
a binder comprising a fluorine-included polymer, the binder in the organic solvent being in a distribution state in a form of an emulsion with a binder particle size of 15 micrometers or less; and
an agent for controlling viscosity.

10. The positive active material composition of claim 9, wherein the binder is in an amount of 2 to 6 wt %.

11. The positive active material composition of claim 10, wherein the binder is in an amount of 2 to 3 wt %.

12. The positive active material composition of claim 9, wherein the fluorine-included polymer is represented by Formula 1: 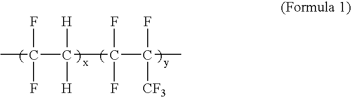
(wherein x is 0.5 to 1.0, and 0<y≦0.5)

13. The positive active material composition of claim 12, wherein y exceeds 0 and is less than 0.2.

14. The positive active material composition of claim 9, wherein the fluorine-included polymer is a homopolymer selected from the group consisting of C₂F₃Cl, C₂H₃F and CH₃(CF₃C₂H₄)SiO, or copolymer including a first monomer and a second monomer, the first monomer being selected from the group consisting of C₂F₄, C₂F₃Cl, CH₂CF₂, C₂H₃F and CH₃(CF₃C₂H₄)SiO, and the second monomer being selected from the group consisting of C₂H₄, C₃H₆, CH₂═CHOR (R is a C₁ to C₂₀ alkyl group), C₃F₆ and CF₂═CFOR_{f}(R_{f} is a C₁ to C₂₀ alkyl group with at least one fluorine atom).

15. The positive active material composition of claim 9, further comprising a butadiene-included copolymer.

16. The positive active material composition of claim 15, wherein the butadiene-included copolymer is selected from the group consisting of acrylonitrile-butadiene-styrene rubber, acrylonitrile-butadiene rubber and a modified styrene-butadiene rubber.

17. The positive active material composition of claim 15, wherein the butadiene-included copolymer is represented by Formula 2: 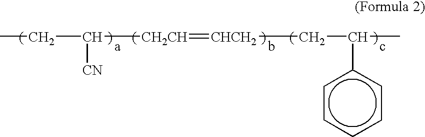
(wherein a is 0, 5<b<40, and 60<c<95;
60<a<95, 5<b<40, and c is 0; or
20<a<75, 5<b<20, and 20<c<75)

18. The positive active material composition of claim 15, wherein the butadiene-included copolymer is non-aqueous.

19. The positive active material composition of claim 15, wherein the agent for controlling viscosity is selected from the group consisting of methyl cellulose, hydroxypropyl methyl cellulose, hydroxyethyl cellulose, carboxymethyl cellulose, polyvinyl alcohol, polyvinylpyrrolidone, polyacrylic acid, polyacrylamide, polyethylene oxide and polyethyleneimine.

20. A lithium-sulfur battery comprising
a positive electrode comprising a positive active material, a conductive agent, and a binder comprising a fluorine-included polymer;
a negative electrode; and
an electrolyte.

21. The lithium-sulfur battery of claim 20, wherein the fluorine-included polymer is represented by Formula 1: 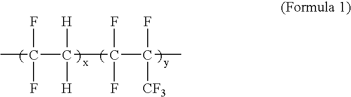
(wherein x is 0.5 to 1.0, and 0<y≦0.5)

22. The lithium-sulfur battery of claim 21, wherein y exceeds 0, and is less than 0.2.

23. The lithium-sulfur battery of claim 20, wherein the fluorine-included polymer is a homopolymer selected from the group consisting of C₂F₃Cl, C₂H₃F and CH₃(CF₃C₂H₄)SiO, or copolymer including a first monomer and a second monomer, the first monomer being selected from the group consisting of C₂F₄, C₂F₃Cl, CH₂CF₂, C₂H₃F and CH₃(CF₃C₂H₄)SiO, and the second monomer being selected from the group consisting of C₂H₄, C₃H₆, CH₂═CHOR (R is a C₁ to C₂₀ alkyl group), C₃F₆ and CF₂=CFOR_{f} (R_{f} is a C₁ to C₂₀ alkyl group with at least one fluorine atom).

24. The lithium-sulfur battery of claim 20, further comprising a butadiene-included copolymer.

25. The lithium-sulfur battery of claim 24, wherein the butadiene-included copolymer is selected from the group consisting of acrylonitrile-butadiene-styrene rubber, acrylonitrile-butadiene rubber and a modified styrene-butadiene rubber.

26. The lithium-sulfur battery of claim 24, wherein the butadiene-included copolymer is represented by Formula 2: 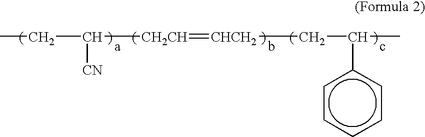
(wherein a is 0, 5<b<40, and 60<c<95;
60<a<95, 5<b<40, and c is 0; or
20<a<75, 5<b<20, and 20<c<75)

27. The lithium-sulfur battery of claim 24, wherein the butadiene-included copolymer is non-aqueous.
